(19) United States
(12) Patent Application Publication
(10) Pub. No.: US 2025/0062436 A1
(43) Pub. Date: Feb. 20, 2025

(54) Device for Heating Battery Cell

(71) Applicant: SK On Co., Ltd., Seoul (KR)

(72) Inventors: Sung Woo LEE, Daejeon (KR); Tae Kon KO, Daejeon (KR)

(21) Appl. No.: 18/802,094

(22) Filed: Aug. 13, 2024

(30) Foreign Application Priority Data
Aug. 17, 2023 (KR) 10-2023-0107496

(51) Int. Cl. H01M 10/615; H01M 10/633; H01M 10/647; H01M 10/657

(52) U.S. Cl. CPC H01M 10/615; H01M 10/633; H01M 10/647; H01M 10/657

(57) ABSTRACT

A battery cell heating device is disclosed. A battery cell heating device based on an embodiment of the disclosed technology is a battery cell heating device applying heat to a battery cell. The battery cell heating device may comprise a heating member that is in contact with the battery cell and is formed of a material including a metal, and a magnetic field generator configured to provide a time-varying magnetic flux to the heating member.

### CROSS-REFERENCE TO RELATED APPLICATIONS

This patent document claims the priority and benefits of Korean Patent Application No. 10-2023-0107496 filed on Aug. 17, 2023, which is incorporated herein by reference in its entirety.

### TECHNICAL FIELD

The technology and implementations disclosed in this patent document relate to a battery cell heating device.

### BACKGROUND

With respect to the stability or safety of secondary batteries, it is necessary to test the secondary batteries when they are exposed to fire. A heating method that can finely adjust a temperature of the secondary batteries may be required.

### SUMMARY

An object of the disclosed technology is to provide a battery cell heating device that can finely adjust a temperature of a battery cell.

Another object of the disclosed technology is to provide a battery cell heating device that can differently heat areas of a battery cell.

In one aspect of the disclosed technology, there is provided a battery cell heating device applying heat to a battery cell comprising a heating member that is in contact with the battery cell and is formed of a material including a metal; and a magnetic field generator configured to provide a time-varying magnetic flux to the heating member.

The heating member may include at least one of a bottom heating member in contact with a bottom surface of the battery cell, a top heating member in contact with a top surface of the battery cell, a front heating member in contact with a front surface of the battery cell, or a rear heating member in contact with a rear surface of the battery cell.

The battery cell heating device may further comprise a mover coupled to the magnetic field generator and configured to adjust a position of the magnetic field generator.

The battery cell heating device may further comprise a magnetic field screen including a screen body positioned between the magnetic field generator and the heating member and a screen opening formed in the screen body.

A surface of the screen body may face the magnetic field generator, and another surface of the screen body may face the heating member.

The screen opening may be connected to the surface and the another surface of the screen body.

The battery cell heating device may further comprise a mover coupled to at least one of the magnetic field generator or the magnetic field screen and configured to move the at least one of the magnetic field generator or the magnetic field screen.

The magnetic field generator and the heating member may be arranged vertically, and the mover may move horizontally at least one of the magnetic field generator or the magnetic field screen coupled to the mover.

The mover may include a moving frame coupled to at least one of the magnetic field generator or the magnetic field screen, a moving coupler coupled to the moving frame and configured to transfer a driving force to the moving frame, and a moving driver coupled to the moving coupler and configured to generate the driving force and to transfer the driving force to the moving coupler.

The moving frame and the moving coupler may form a rack-pinion coupling structure.

The battery cell heating device may further comprise a sensor unit configured to measure a temperature of at least one of the heating member or the battery cell.

The battery cell heating device may further comprise a control unit connected to the sensor unit and configured to acquire temperature information, and the control unit may control the magnetic field generator based on the temperature information.

In another aspect of the disclosed technology, there is provided a battery cell heating device comprising a heating member formed of a material including a metal; a magnetic field generator configured to provide a time-varying magnetic flux to the heating member; and a magnetic field screen including a screen body positioned between the heating member and the magnetic field generator and a screen opening formed in the screen body, wherein the screen body blocks the time-varying magnetic flux.

The battery cell heating device may further comprise a mover coupled to at least one of the magnetic field generator or the magnetic field screen and configured to move the at least one of the magnetic field generator or the magnetic field screen.

The magnetic field generator and the heating member may be arranged vertically, and the mover may move horizontally at least one of the magnetic field generator or the magnetic field screen coupled to the mover.

The battery cell heating device may further comprise a sensor unit configured to measure a temperature of the heating member.

The battery cell heating device may further comprise a control unit connected to the sensor unit and configured to acquire temperature information, and the control unit may control the magnetic field generator and the mover based on the temperature information.

In another aspect of the disclosed technology, there is provided a battery cell heating device comprising a heating member formed of a material including a metal; a magnetic field generator configured to provide a time-varying magnetic flux to the heating member; a sensor unit configured to measure a temperature of the heating member; and a control unit connected to the sensor unit and configured to acquire temperature information, wherein the control unit is further configured to control the magnetic field generator based on the temperature information.

The battery cell heating device may further comprise a mover coupled to the magnetic field generator and configured to move the magnetic field generator, and the control unit may control the magnetic field generator and the mover based on the temperature information.

The magnetic field generator and the heating member may be arranged vertically, and the mover may move horizontally the magnetic field generator.

According to at least one embodiment of the disclosed technology, there can be provided a battery cell heating device that can finely adjust a temperature of a battery cell.

According to at least one embodiment of the disclosed technology, there can be provided a battery cell heating device that can differently heat areas of a battery cell.

A battery cell heating device based on some embodiments of the disclosed technology can be widely applied in green technology fields such as electric vehicles, battery charging stations, and other battery-based solar power generation and wind power generation.

A battery cell heating device based on some embodiments of the disclosed technology can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery cell.

FIG. 2 illustrates a cross section of a battery cell taken along line A1-A2 of FIG. 1.

FIG. 3 illustrates a magnetic field generator based on an embodiment of the disclosed technology.

FIG. 4 illustrates a magnetic field screen based on an embodiment of the disclosed technology.

FIG. 5 illustrates that a magnetic field generator and a magnetic field screen face each other.

FIG. 6 illustrates a magnetic field providing unit including a mover.

FIG. 7 illustrates a battery cell and a heating member positioned below the battery cell.

FIG. 8 illustrates a battery cell and a heating member surrounding a perimeter of the battery cell.

FIG. 9 illustrates a cross section of a battery cell and a heating member taken along line B1-B2 of FIG. 8.

FIG. 10 illustrates a battery cell and a heating member in contact with a front surface and a rear surface of the battery cell.

FIG. 11 illustrates a battery cell and a heating member in contact with an electrode lead.

FIG. 12 is a block diagram illustrating a battery cell heating device based on an embodiment of the disclosed technology.

### DETAILED DESCRIPTION

Reference will now be made in detail to embodiments of the disclosed technology, examples of which are illustrated in the accompanying drawings. However, the following description is merely an example and does not intended to limit the disclosed technology to a specific implementation.

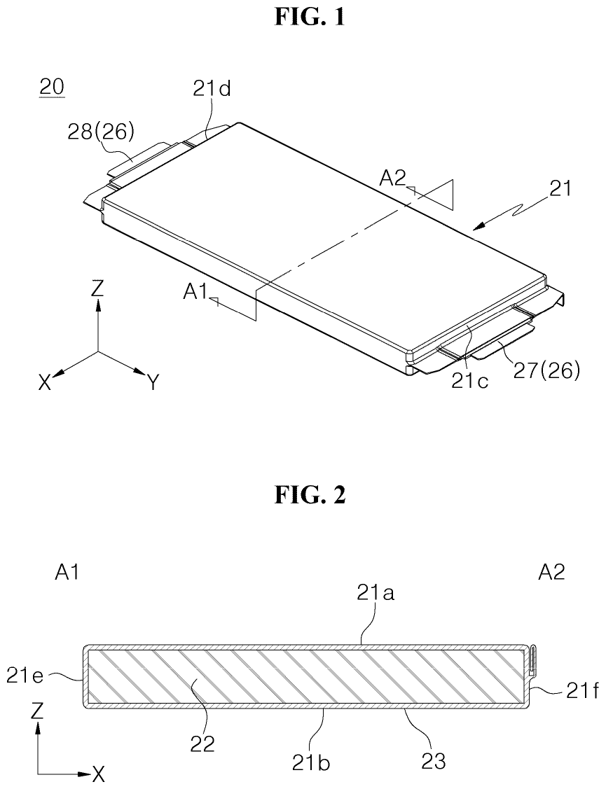

FIG. 1 illustrates a battery cell. FIG. 2 illustrates a cross section of a battery cell taken along A1-A2 of FIG. 1.

Referring to FIGS. 1 and 2, a battery cell 20 may be a pouch battery cell. The battery cell 20 may include a cell body 21. The cell body 21 may form an overall hexahedral shape. For example, an outer surface of the cell body 21 may be divided into six surfaces.

For example, the outer surface of the cell body 21 may include a cell top surface 21a, a cell bottom surface 21b, a first cell surface 21c, a second cell surface 21d, a cell front surface 21e, and a cell rear surface 21f. The cell top surface 21a may form a top surface of the cell body 21. The cell bottom surface 21b may form a bottom surface of the cell body 21.

The cell top surface 21a and the cell bottom surface 21b may be positioned opposite to each other. The cell top surface 21a and the cell bottom surface 21b may form a relatively wide surface among the outer surfaces of the cell body 21.

The cell front surface 21e may form a front surface of the cell body 21. The cell rear surface 21f may form a rear surface of the cell body 21. The first cell surface 21c may form a right side surface of the cell body 21. The second cell surface 21d may form a left side surface of the cell body 21.

The cell body 21 may form a shape extending in one direction. For example, the cell body 21 may form a shape extending in a longitudinal direction of the cell body 21. For example, the cell body 21 may extend from the first cell surface 21c to the second cell surface 21d.

The longitudinal direction of the cell body 21 may be a direction in which the cell body 21 extends. For example, the longitudinal direction of the cell body 21 may be parallel to a direction from the first cell surface 21c to the second cell surface 21d. For example, the longitudinal direction of the cell body 21 may be a left-right direction. For example, the longitudinal direction of the cell body 21 may be parallel to a Y-axis direction.

A width direction of the cell body 21 may be parallel to a direction in which the first cell surface 21c extends. The width direction of the cell body 21 may be parallel to a direction in which the second cell surface 21d extends. For example, the width direction of the cell body 21 may be a front-rear direction. For example, the width direction of the cell body 21 may be parallel to an X-axis direction.

A thickness direction of the cell body 21 may be parallel to a direction from the cell top surface 21a to the cell bottom surface 21b. The thickness direction of the cell body 21 may be an up-down direction. For example, the thickness direction of the cell body 21 may be parallel to a Z-axis direction.

A plurality of battery cells 20 may be stacked. For example, the plurality of battery cells 20 may be stacked in the thickness direction of the cell body 21. For example, in both battery cells 20 of the plurality of battery cells 20, the cell bottom surface 21b of the top battery cell 20 may face the cell top surface 21a of the bottom battery cell 20.

The cell body 21 may include an electrode assembly 22. The electrode assembly 22 may include an anode, a cathode, and a separator. The electrode assembly 22 may have electrical energy. For example, the electrode assembly 22 may be charged or discharged.

The battery cell 20 may include an exterior material 23. The exterior material 23 may accommodate the electrode assembly 22. The exterior material 23 may be sealed. For example, the exterior material 23 may form a sealed space accommodating the electrode assembly 22. A portion of the exterior material 23 may form the cell body 21.

The battery cell 20 may include an electrode lead 26. The electrode lead 26 may extend from the electrode assembly 22. The electrode lead 26 may protrude from the cell body 21. For example, the electrode lead 26 may protrude from an end of the cell body 21.

A plurality of electrode leads 26 may be provided. For example, a first electrode lead 27 may protrude from the first cell surface 21c. For example, a second electrode lead 28 may protrude from the second cell surface 21d.

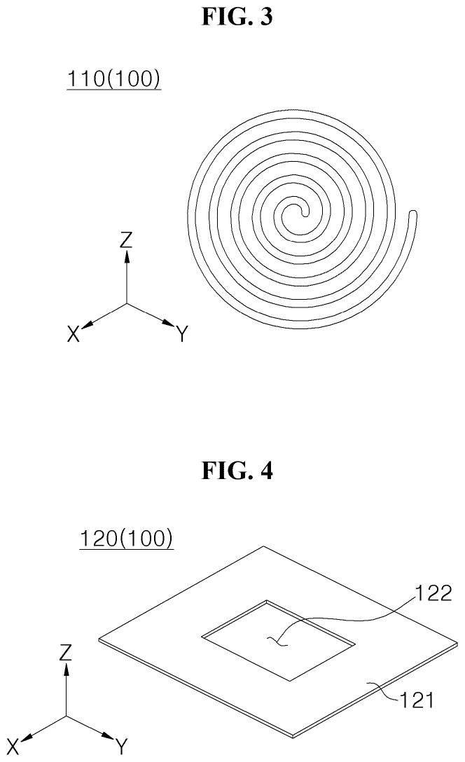

FIG. 3 illustrates a magnetic field generator based on an embodiment of the disclosed technology.

Referring to FIG. 3, a magnetic field providing unit 100 may include a magnetic field generator 110. The magnetic field generator 110 may include, for example, a coil. When a current or voltage is applied to the magnetic field generator 110, the magnetic field generator 110 may form a magnetic field or a magnetic flux.

FIG. 4 illustrates a magnetic field screen based on an embodiment of the disclosed technology.

Referring to FIG. 4, the magnetic field providing unit 100 may include a magnetic field screen 120. The magnetic field screen 120 may include a screen body 121. The screen body 121 may block the magnetic field or the magnetic flux.

A permeability of the screen body 121 may be relatively high. For example, the screen body 121 may be formed of a material containing a metal with a relatively high permeability. The screen body 121 may form the shape of a plate.

The magnetic field screen 120 may include a screen opening 122. The screen opening 122 may be an opening formed in the screen body 121. Although not illustrated in the drawing, a member with a lower permeability than the permeability of the screen body 121 may be positioned in the screen opening 122.

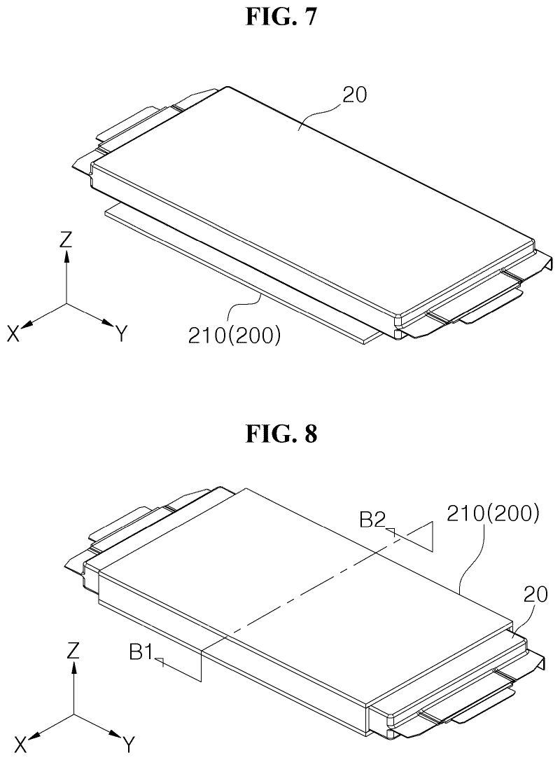

A surface of the screen body 121 may face the magnetic field generator 110 (see FIG. 3). Another surface of the screen body 121 may face a heating member 210 (see FIGS. 7 to 11). The screen opening 122 may be connected to the surface and the another surface of the screen body 121. The surface of the screen body 121 may be, for example, a bottom surface of the screen body 121. The another surface of the screen body 121 may be, for example, a top surface of the screen body 121.

FIG. 5 illustrates that a magnetic field generator and a magnetic field screen face each other. In FIG. 5, a cross section of the magnetic field providing unit 100 may be illustrated, for convenience of explanation. For example, in FIG. 5, a vertical cross section of the magnetic field providing unit 100 may be illustrated. In FIG. 5, the magnetic field generator 110 may be illustrated as a dotted line, for convenience of explanation.

Referring to FIG. 5, the magnetic field generator 110 and the magnetic field screen 120 may face each other. The magnetic field generator 110 and the magnetic field screen 120 may be spaced apart from each other. The magnetic field generator 110 may be positioned below the magnetic field screen 120.

Electric power may be provided to the magnetic field generator 110. For example, the magnetic field generator 110 may receive alternating current power. The magnetic field generator 110 may form a magnetic flux MF. For example, the magnetic flux MF may extend toward the magnetic field screen 120.

Referring to FIGS. 3 to 5, the magnetic flux MF may meet the screen body 121. For example, the bottom surface of the screen body 121 may meet the magnetic flux MF. When the magnetic flux MF meets the screen body 121, energy of the magnetic flux MF may be consumed in magnetizing the screen body 121.

For example, when the magnetic flux MF meets the bottom surface of the screen body 121, the magnetic flux MF may not travel upwards of the screen body 121. In other words, the screen body 121 may block or suppress the magnetic flux MF from travelling. The magnetic flux MF may pass through the screen opening 122. As a result, the magnetic field screen 120 may selectively transmit the magnetic flux MF.

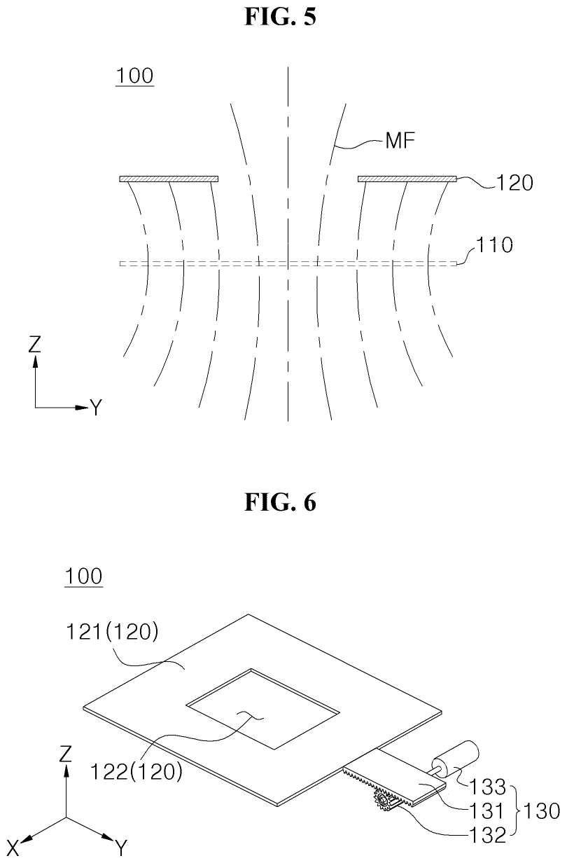

FIG. 6 illustrates a magnetic field providing unit including a mover.

Referring to FIG. 6, the magnetic field providing unit 100 may include a mover 130. For example, the mover 130 may be coupled to the magnetic field screen 120 to move the magnetic field screen 120. For another example, the mover 130 may be coupled to the magnetic field generator 110 (see FIG. 3) to move the magnetic field generator 110 (see FIG. 3).

The mover 130 may include a moving frame 131. For example, the moving frame 131 may be coupled to the magnetic field screen 120. For example, the moving frame 131 may be coupled to the magnetic field generator 110 (see FIG. 3).

The mover 130 may include a moving coupler 132. The moving coupler 132 may be coupled to the moving frame 131. For example, the moving frame 131 and the moving coupler 132 may form a rack-pinion coupling structure. For example, the moving frame 131 may form a rack, and the moving coupler 132 may form a pinion. For example, when the moving coupler 132 rotates, the moving frame 131 may move in translation.

The mover 130 may include a moving driver 133. The moving driver 133 may be connected or coupled to the moving coupler 132. The moving driver 133 may provide a driving force to the moving coupler 132. For example, the moving driver 133 may provide a rotational force to the moving coupler 132.

The moving driver 133 may include a motor. For example, the moving driver 133 may include a stepping motor or/and a servo motor.

The magnetic field screen 120 may move. For example, the magnetic field screen 120 may move in a direction transverse to a direction passing through the screen opening 122. For example, the screen opening 122 may be penetrated in a vertical direction (Z-axis direction), and the magnetic field screen 120 may move on a horizontal plane. Hence, the distribution of a space where the magnetic flux MF (see FIG. 5) is provided may vary.

For another example, the magnetic field generator 110 (see FIGS. 3 and 5) may move. For example, the magnetic field generator 110 (see FIGS. 3 and 5) may move in a direction transverse to a direction in which the magnetic flux MF (see FIG. 5) travels.

For example, the magnetic flux MF (see FIG. 5) may travel in the vertical direction (Z-axis direction) in the magnetic field generator 110 (see FIGS. 3 and 5), and the magnetic field generator 110 (see FIGS. 3 and 5) may move on the horizontal plane. Hence, the distribution of the space where the magnetic flux MF (see FIG. 5) is provided may vary.

FIG. 7 illustrates a battery cell and a heating member positioned below the battery cell.

Referring to FIGS. 1 to 7, a heater unit 200 may include a heating member 210. The heating member 210 may include a conductive material. For example, the heating member 210 may be formed of a material containing metal.

When a time-varying magnetic flux is applied to the heating member 210, a current may occur in the heating member 210 according to Lenz's law. When the current occurs in the heating member 210, the heating member 210 may be heated by ohmic heating.

When the heating member 210 is heated, a temperature of the heating member 210 may relatively rise. If the temperature of the heating member 210 is higher than a temperature of the battery cell 20, heat energy may move from the heating member 210 to the battery cell 20. That is, the heating member 210 may heat the battery cell 20.

The heating member 210 may heat a surface of the battery cell 20. For example, the heating member 210 may be in contact with the cell bottom surface 21b (see FIG. 2) of the battery cell 20 and may provide heat energy to the battery cell 20.

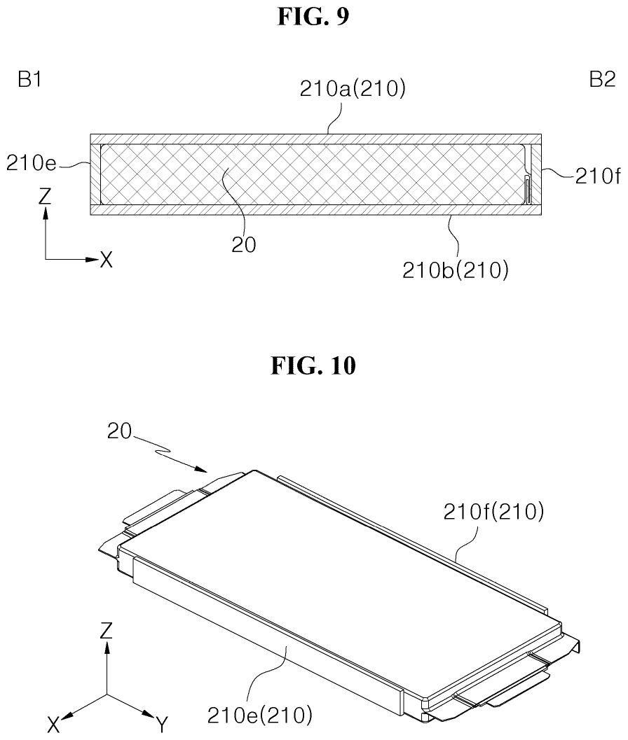

FIG. 8 illustrates a battery cell and a heating member surrounding a perimeter of the battery cell. FIG. 9 illustrates a cross section of a battery cell and a heating member taken along line B1-B2 of FIG. 8.

Referring to FIGS. 8 and 9, the heating member 210 may surround the battery cell 20. In a battery module including the plurality of battery cells 20 that are stacked in the thickness direction of the battery cells 20, when a fire occurs in one battery cell 20, an impact of the fire on the adjacent battery cells 20 can be seen.

For example, the heating member 210 may surround the cell body 21 (see FIG. 1). For example, the heating member 210 may be in contact with the outer surface of the battery cell 20.

For example, the heating member 210 may include a top heating member 210a that is in contact with the cell top surface 21a (see FIG. 2) of the battery cell 20. For example, the magnetic field generator 110 (see FIGS. 3 and 5) may include a top magnetic field generator facing the top heating member 210a.

For example, the heating member 210 may include a bottom heating member 210b that is in contact with the cell bottom surface 21b (see FIG. 2) of the battery cell 20. For example, the magnetic field generator 110 (see FIGS. 3 and 5) may include a bottom magnetic field generator facing the bottom heating member 210b.

For example, the heating member 210 may include a front heating member 210e that is in contact with the cell front surface 21e (see FIG. 2) of the battery cell 20. For example, the magnetic field generator 110 (see FIGS. 3 and 5) may include a front magnetic field generator facing the front heating member 210e.

For example, the heating member 210 may include a rear heating member 210f that is in contact with the cell rear surface 21f (see FIG. 2) of the battery cell 20. For example, the magnetic field generator 110 (see FIGS. 3 and 5) may include a rear magnetic field generator facing the rear heating member 210f.

FIG. 10 illustrates a battery cell and a heating member in contact with a front surface and a rear surface of the battery cell. In a battery module including the plurality of battery cells 20 that are stacked in the thickness direction of the battery cells 20, when a fire occurs outside the battery module, an impact of the fire on the battery cells 20 can be seen.

Referring to FIG. 10, the heating member 210 may include a front heating member 210e that is in contact with the cell front surface 21e (see FIG. 2) of the battery cell 20. The heating member 210 may include a rear heating member 210f that is in contact with the cell rear surface 21f (see FIG. 2) of the battery cell 20.

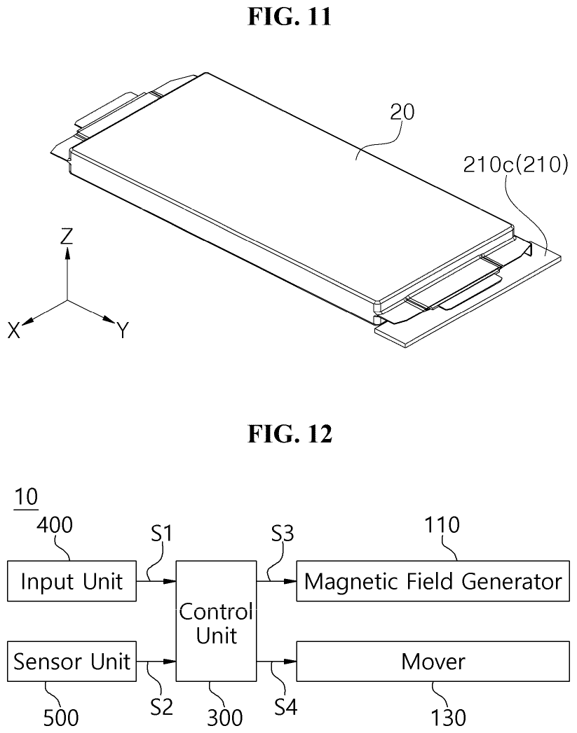

FIG. 11 illustrates a battery cell and a heating member in contact with an electrode lead. In a battery module including the plurality of battery cells 20 that are stacked in the thickness direction of the battery cells 20, when the electrode lead 26 (see FIG. 1) is heated, an impact on the battery cell 20 can be seen.

Referring to FIG. 11, the heating member 210 may include a first surface heating member 210c that is adjacent to the first cell surface 21c (see FIG. 1) of the battery cell 20 and is in contact with the electrode lead 26 (see FIG. 1).

FIG. 12 is a block diagram illustrating a battery cell heating device based on an embodiment of the disclosed technology.

Referring to FIGS. 1 to 12, a battery cell heating device 10 may heat the battery cell 20. For example, the battery cell 20 heated by the battery cell heating device 10 may be at least one of a pouch battery cell, a prismatic battery cell, or a cylindrical battery cell.

The battery cell heating device 10 based on an embodiment of the disclosed technology may include a control unit 300. The control unit 300 may perform computation. The control unit 300 may process signals.

For example, the control unit 300 may receive input signals S1 and S2 and generate output signals S3 and S4 based on the input signals S1 and S2. The input signals S1 and S2 may include or indicate at least one of the first signal S1 or the second signal S2. The output signals S3 and S4 may include or indicate at least one of the third signal S3 or the fourth signal S4.

The battery cell heating device 10 based on an embodiment of the disclosed technology may include an input unit 400. The input unit 400 may obtain an input from a user, etc. The input unit 400 may generate the first signal S1 related to the input and transmit the first signal S1 to the control unit 300.

The battery cell heating device 10 based on an embodiment of the disclosed technology may include a sensor unit 500. The sensor unit 500 may measure a temperature. For example, the sensor unit 500 may measure a temperature of the heating member 210. For example, the sensor unit 500 may measure a temperature of the battery cell 20.

The sensor unit 500 may generate the second signal S2 including information on the temperature and transmit the second signal S2 to the control unit 300. The control unit 300 may obtain information on the temperature of at least one of the heating member 210 or the battery cell 20 based on the second signal S2.

The control unit 300 may generate the third signal S3 based on the input signals S1 and S2. The third signal S3 may include information on the operation of the magnetic field generator 110. For example, the third signal S3 may include information on at least one of a frequency, voltage, current, or waveform of the alternating current power applied to the magnetic field generator 110.

The control unit 300 may transmit the third signal S3 to the magnetic field generator 110. The magnetic field generator 110 may form a magnetic flux MF in response to the third signal S3. The magnetic flux MF applied to the heating member 210 in response to the third signal S3 may form a profile in terms of time and space.

The control unit 300 may generate the fourth signal S4 based on the input signals S1 and S2. The fourth signal S4 may include information on the operation of the mover 130. For example, the fourth signal S4 may include information on a location of at least one of the magnetic field generator 110 or the magnetic field screen 120.

The mover 130 may move at least one of the magnetic field generator 110 or the magnetic field screen 120 in response to the fourth signal S4. When at least one of the magnetic field generator 110 or the magnetic field screen 120 moves, the profile of the magnetic flux MF applied to the heating member 210 may vary.

Accordingly, the battery cell heating device 10 can control the temperature and temperature distribution of the heating member 210. Alternatively, the battery cell heating device 10 may control the temperature and temperature distribution of the battery cell 20.

Only specific examples of implementations of certain embodiments are described. Variations, improvements and enhancements of the disclosed embodiments and other embodiments may be made based on the disclosure of this patent document.

What is claimed is:

1. A battery cell heating device applying heat to a battery cell, the battery cell heating device comprising:
a heating member that is in contact with the battery cell and is formed of a material including a metal; and
a magnetic field generator configured to provide a time-varying magnetic flux to the heating member.

2. The battery cell heating device of claim 1, wherein the heating member includes at least one of:
a bottom heating member in contact with a bottom surface of the battery cell;
a top heating member in contact with a top surface of the battery cell;
a front heating member in contact with a front surface of the battery cell; or
a rear heating member in contact with a rear surface of the battery cell.

3. The battery cell heating device of claim 1, further comprising:
a mover coupled to the magnetic field generator and configured to adjust a position of the magnetic field generator.

4. The battery cell heating device of claim 1, further comprising:
a magnetic field screen including:
a screen body positioned between the magnetic field generator and the heating member; and
a screen opening formed in the screen body.

5. The battery cell heating device of claim 4, wherein a surface of the screen body faces the magnetic field generator, and
wherein another surface of the screen body faces the heating member.

6. The battery cell heating device of claim 5, wherein the screen opening is connected to the surface and the another surface of the screen body.

7. The battery cell heating device of claim 4, further comprising:
a mover coupled to at least one of the magnetic field generator or the magnetic field screen and configured to move the at least one of the magnetic field generator or the magnetic field screen.

8. The battery cell heating device of claim 7, wherein the magnetic field generator and the heating member are arranged vertically, and
wherein the mover moves horizontally at least one of the magnetic field generator or the magnetic field screen coupled to the mover.

9. The battery cell heating device of claim 8, wherein the mover includes:
a moving frame coupled to at least one of the magnetic field generator or the magnetic field screen;
a moving coupler coupled to the moving frame and configured to transfer a driving force to the moving frame; and
a moving driver coupled to the moving coupler and configured to generate the driving force and to transfer the driving force to the moving coupler.

10. The battery cell heating device of claim 9, wherein the moving frame and the moving coupler form a rack-pinion coupling structure.

11. The battery cell heating device of claim 1, further comprising:
a sensor unit configured to measure a temperature of at least one of the heating member or the battery cell.

12. The battery cell heating device of claim 11, further comprising:
a control unit connected to the sensor unit and configured to acquire temperature information,
wherein the control unit is further configured to control the magnetic field generator based on the temperature information.

13. A battery cell heating device comprising:
a heating member formed of a material including a metal;
a magnetic field generator configured to provide a time-varying magnetic flux to the heating member; and
a magnetic field screen including a screen body positioned between the heating member and the magnetic field generator and a screen opening formed in the screen body,
wherein the screen body blocks the time-varying magnetic flux.

14. The battery cell heating device of claim 13, further comprising:
a mover coupled to at least one of the magnetic field generator or the magnetic field screen and configured to move the at least one of the magnetic field generator or the magnetic field screen.

15. The battery cell heating device of claim 14, wherein the magnetic field generator and the heating member are arranged vertically, and
wherein the mover moves horizontally at least one of the magnetic field generator or the magnetic field screen coupled to the mover.

16. The battery cell heating device of claim 14, further comprising:
a sensor unit configured to measure a temperature of the heating member.

17. The battery cell heating device of claim 16, further comprising:
a control unit connected to the sensor unit and configured to acquire temperature information,
wherein the control unit is further configured to control the magnetic field generator and the mover based on the temperature information.

18. A battery cell heating device comprising:
a heating member formed of a material including a metal;
a magnetic field generator configured to provide a time-varying magnetic flux to the heating member;
a sensor unit configured to measure a temperature of the heating member; and
a control unit connected to the sensor unit and configured to acquire temperature information,
wherein the control unit is further configured to control the magnetic field generator based on the temperature information.

19. The battery cell heating device of claim 18, further comprising:
a mover coupled to the magnetic field generator and configured to move the magnetic field generator,
wherein the control unit is configured to control the magnetic field generator and the mover based on the temperature information.

20. The battery cell heating device of claim 19, wherein the magnetic field generator and the heating member are arranged vertically, and
wherein the mover moves horizontally the magnetic field generator.
